(19) United States
(12) Patent Application Publication
(10) Pub. No.: US 2023/0213697 A1
(43) Pub. Date: Jul. 6, 2023

(54) BACKLIGHT MODULE AND DISPLAY APPARATUS

(71) Applicant: Coretronic Corporation, Hsin-Chu (TW)

(72) Inventors: Tzeng-Ke Shiau, Hsin-Chu (TW); Hsuan Chou, Hsin-Chu (TW); Hung-Li Pan, Hsin-Chu (TW); Yi-Cheng Lin, Hsin-Chu (TW); Chia-Liang Kang, Hsin-Chu (TW); Shih-Wei Liu, Hsin-Chu (TW); Wei-Chun Yang, Hsin-Chu (TW); Cheng-Yi Tseng, Hsin-Chu (TW)

(73) Assignee: Coretronic Corporation, Hsin-Chu (TW)

(21) Appl. No.: 18/084,571

(22) Filed: Dec. 20, 2022

(30) Foreign Application Priority Data
Dec. 31, 2021 (CN) 202123418738.4

(51) Int. Cl. F21V 8/00

(52) U.S. Cl. CPC G02B 6/0036

(57) ABSTRACT

A backlight module includes a light guide plate, a light source, multiple first optical microstructures, and multiple second optical microstructures. The first optical microstructures and the second optical microstructures are disposed on the bottom surface of the light guide plate. Each of the first optical microstructures has a first light receiving surface facing the light source.

Each of the second optical microstructures has a second light receiving surface facing the light source. A first angle is included between the first light receiving surface and the bottom surface. A second angle is included between the second light receiving surface and the bottom surface. The second angle is different from the first angle. A display apparatus adopting the backlight module is also provided.

### CROSS-REFERENCE TO RELATED APPLICATION

This application claims the priority benefit of China application serial no. 202123418738.4, filed on Dec. 31, 2021. The entirety of the above-mentioned patent application is hereby incorporated by reference herein and made a part of this specification.

### BACKGROUND

### Technical Field

The disclosure relates to a light source module and a display apparatus, and more particularly relates to a backlight module and a display apparatus.

### Description of Related Art

With the increasing application of non-self-luminous displays such as liquid crystal displays, the design of a backlight module also needs to be adjusted for different usage scenarios. Generally speaking, the optical microstructure on a light guide plate will be designed in consideration of the optical film used in the backlight module to generate the desired light emitting distribution. However, the light emitting distribution of such a backlight module adopting a light guide plate with a single optical microstructure design does not have high tunability.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a backlight module with better design flexibility of the light emitting distribution.

The disclosure provides a display apparatus with better tunability of the viewing angle distribution of the display brightness.

Other objectives and advantages of the disclosure may be further understood from the technical features disclosed in the disclosure.

In order to achieve one or part or all of the above objectives or other objectives, an embodiment of the disclosure proposes a backlight module. The backlight module includes a light guide plate, a light source, multiple first optical microstructures, and multiple second optical microstructures. The light guide plate has a light incident surface, a light emitting surface, and a bottom surface. The light emitting surface and the bottom surface are opposite to each other, and both are connected to the light incident surface. The light source is disposed on one side of the light incident surface of the light guide plate. The first optical microstructures and the second optical microstructures are disposed on the bottom surface of the light guide plate. Each of the first optical microstructures has a first light receiving surface facing the light source. Each of the second optical microstructures has a second light receiving surface facing the light source. A first angle is included between the first light receiving surface and the bottom surface. A second angle is included between the second light receiving surface and the bottom surface. The second angle is different from the first angle.

In order to achieve one or part or all of the above objectives or other objectives, an embodiment of the disclosure proposes a display apparatus. The display apparatus includes a backlight module and a display panel. The backlight module includes a light guide plate, a light source, multiple first optical microstructures, and multiple second optical microstructures. The light guide plate has a light incident surface, a light emitting surface, and a bottom surface. The light emitting surface and the bottom surface are opposite to each other, and both are connected to the light incident surface. The light source is disposed on one side of the light incident surface of the light guide plate. The first optical microstructures and the second optical microstructures are disposed on the bottom surface of the light guide plate. Each of the first optical microstructures has a first light receiving surface facing the light source. Each of the second optical microstructures has a second light receiving surface facing the light source. A first angle is included between the first light receiving surface and the bottom surface. A second angle is included between the second light receiving surface and the bottom surface. The second angle is different from the first angle. The display panel is disposed on one side of the light emitting surface of the light guide plate and overlaps the light emitting surface.

Based on the above, in the backlight module of an embodiment of the disclosure, the bottom surface of the light guide plate is disposed with two kind of optical microstructures with different light receiving angles. Through the number ratio of the two kind of optical microstructures, backlight modules with different light emitting distributions may be designed to meet various application requirements of display apparatuses.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a display apparatus according to the first embodiment of the disclosure.

FIG. 2 is a schematic bottom view of the backlight module of FIG. 1.

FIG. 3 is a curve graph of normalized brightness value versus viewing angle after light is reflected, respectively, by the first optical microstructure and the second optical microstructure of FIG. 1.

FIG. 4 is a curve graph of normalized brightness value versus viewing angle of the backlight module of FIG. 1.

FIG. 5 is a curve graph of normalized brightness value versus viewing angle after light is reflected, respectively, by the first optical microstructure and the second optical microstructure of another embodiment.

FIG. 6 is a curve graph of normalized brightness value versus viewing angle of another modified embodiment of the backlight module of FIG. 1.

FIG. 7 is a schematic cross-sectional view of a backlight module according to the second embodiment of the disclosure.

FIG. 8 is a schematic cross-sectional view of a backlight module according to the third embodiment of the disclosure.

FIG. 9 is a schematic cross-sectional view of another modified embodiment of the backlight module of FIG. 1.

FIG. 10 is a schematic cross-sectional view of a backlight module according to the fourth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

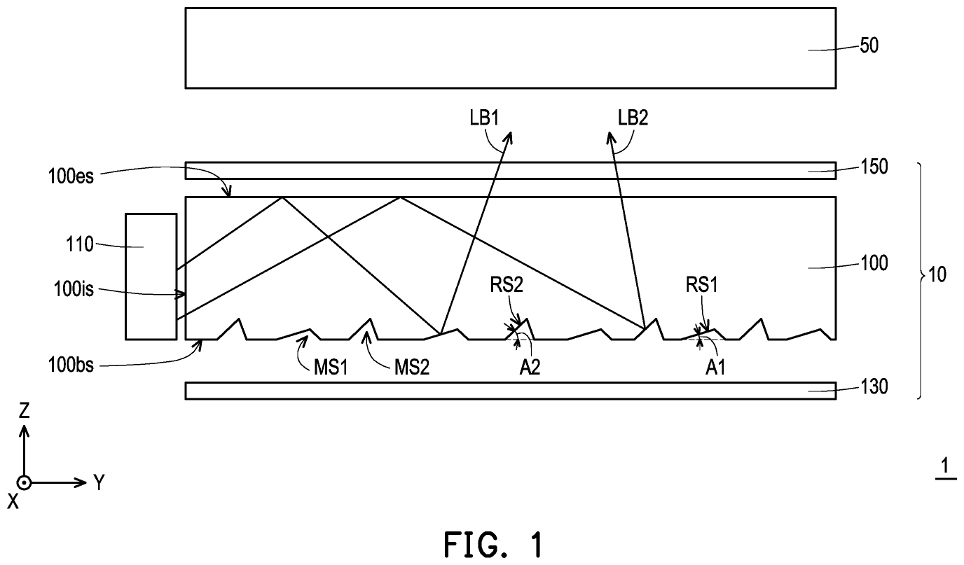

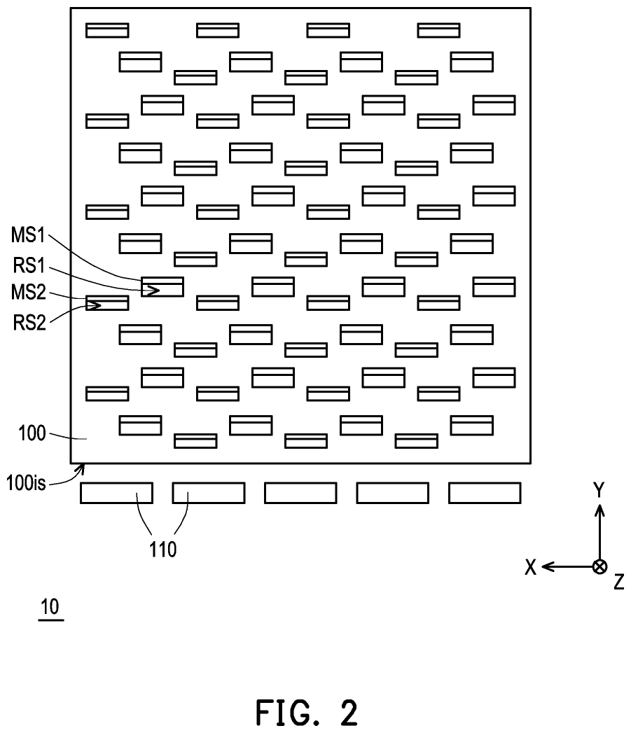

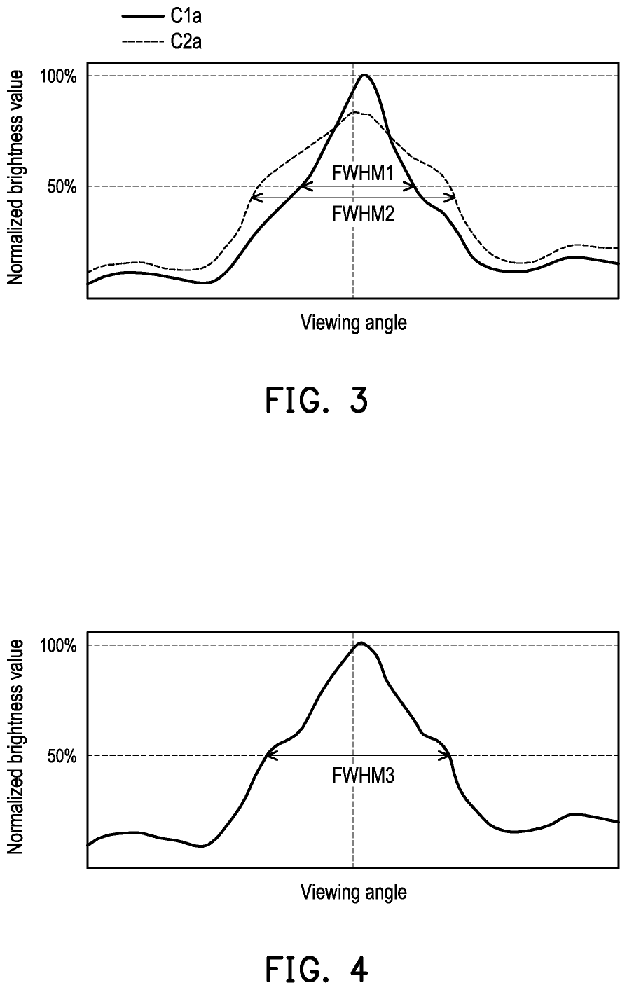

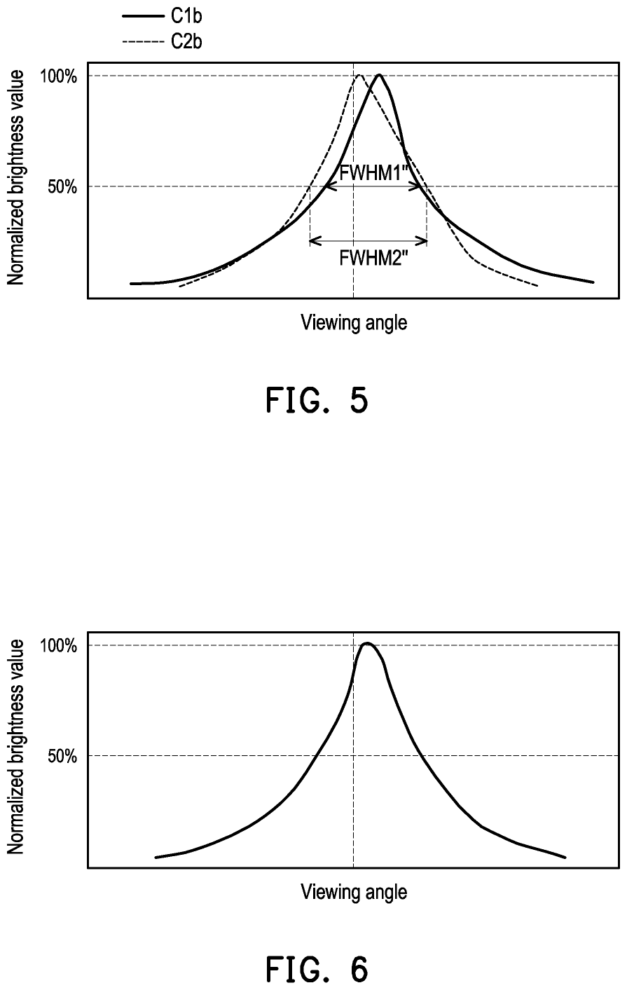

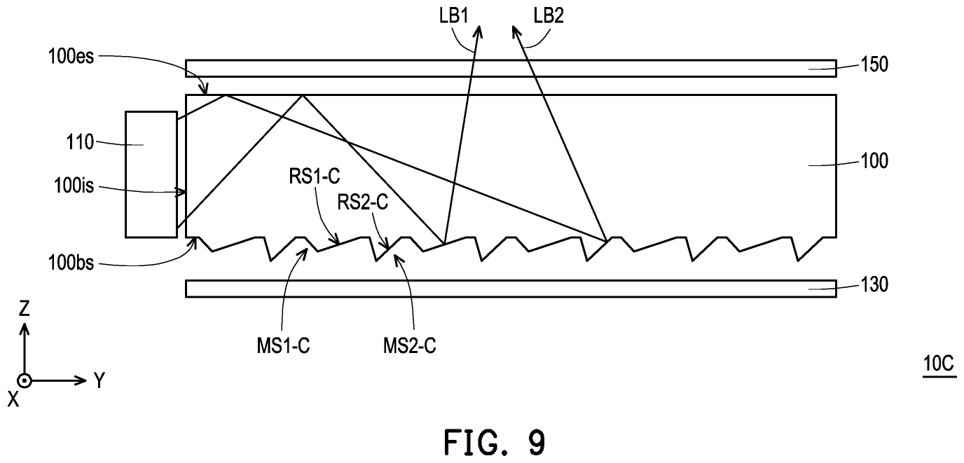

FIG. 1 is a schematic cross-sectional view of a display apparatus according to the first embodiment of the disclosure. FIG. 2 is a schematic bottom view of the backlight module of FIG. 1. FIG. 3 is a curve graph of normalized brightness value versus viewing angle after light is reflected, respectively, by the first optical microstructure and the second optical microstructure of FIG. 1. FIG. 4 is a curve graph of normalized brightness value versus viewing angle of the backlight module of FIG. 1. FIG. 5 is a curve graph of normalized brightness value versus viewing angle after light is reflected, respectively, by the first optical microstructure and the second optical microstructure of another embodiment. FIG. 6 is a curve graph of normalized brightness value versus viewing angle of another modified embodiment of the backlight module of FIG. 1. FIG. 9 is a schematic cross-sectional view of another modified embodiment of the backlight module of FIG. 1. For clarity of presentation, FIG. 2 only illustrates the light guide plate 100, the light source 110, the first optical microstructure MS1, and the second optical microstructure MS2 of FIG. 1.

Please refer to FIGS. 1 and 2. The display apparatus 1 includes a backlight module 10 and a display panel 50. The backlight module 10 includes a light guide plate 100 and a light source 110. The light guide plate 100 has a light incident surface 100is, a light emitting surface 100es, and a bottom surface 100bs. The light emitting surface 100es and the bottom surface 100bs are connected to the light incident surface 100is and opposite to each other. The light source 110 is disposed on one side of the light incident surface 100is of the light guide plate 100 and is adapted for providing multiple light beams. After entering the light incident surface 100is of the light guide plate 100, these light beams may be transmitted in the light guide plate 100 in a direction away from the light source 110 through multiple total reflections. In the embodiment, the light source 110 is, for example, a combination of multiple light emitting diodes, but is not limited thereto.

The bottom surface 100bs of the light guide plate 100 is disposed with multiple first optical microstructures MS1 and multiple second optical microstructures MS2. In the embodiment, the optical microstructures (the multiple first optical microstructures MS1 and the multiple second optical microstructures MS2) on the light guide plate 100 are, for example, groove structures recessed from the bottom surface 100bs into the body of the light guide plate 100, but are not limited thereto. In other embodiments, the optical microstructure on the light guide plate 100 may further be a convex structure protruding from the bottom surface 100bs out of the body of the light guide plate 100, as the first optical microstructure MS1-C and the second optical microstructure MS2-C of the backlight module 10C shown in FIG. 9. Therefore, the first light receiving surface RS1-C of the first optical microstructure MS1-C is located on the side of the first optical microstructure MS1-C farther from the light source 110, and the second light receiving surface RS2-C of the second optical microstructure MS2-C is located on the side of the second optical microstructure MS2-C farther away from the light source 110.

Please continue to refer to FIGS. 1 and 2. It should be particularly noted that the first optical microstructure MS1 and the second optical microstructure MS2 have, respectively, a first light receiving surface RS1 and a second light receiving surface RS2 facing the light source 110. A first angle A1 is included between the first light receiving surface RS1 and the bottom surface 100bs, and a second angle A2 is included between the second light receiving surface RS2 and the bottom surface 100bs. Moreover, the second angle A2 is different from the first angle A1.

In other words, the light guide plate 100 of the disclosure is disposed with two kind of optical microstructures with different light receiving angles. A part of the light beams (for example, a light beam LB1) transmitted in the light guide plate 100 emits from the light emitting surface 100es after being reflected by the first light receiving surfaces RS1 of the multiple first optical microstructures MS1, and has a first light distribution. Another part of the light beams (for example, a light beam LB2) emits from the light emitting surface 100es after being reflected by the second light receiving surfaces RS2 of the multiple second optical microstructures MS2, and has a second light distribution. Through the superposition of these two light distributions, the design flexibility of the overall light emitting distribution of the backlight module 10 may be increased to meet various application requirements of the display apparatus 1.

For example, when the display apparatus 1 needs to have a higher brightness value near the front viewing angle and at the same time meet a larger viewing angle specification, the above-mentioned first light distribution and the second light distribution may be designed as a concentrated light distribution and a diffused light distribution, respectively. Moreover, through the superimposed effect, the desired target light distribution is generated. Therefore, the first angle A1 of the first light receiving surface RS1 has to be smaller than the second angle A2 of the second light receiving surface RS2, and the absolute value of the difference between the first angle A1 and the second angle A2 may be greater than or equal to 5 degrees. However, the disclosure is not limited thereto. In order to increase the difference between the two kind of light distributions to meet the requirements of different target light distributions, the absolute value of the difference between the first angle A1 and the second angle A2 may also be greater than or equal to 8 degrees, or even greater than or equal to 10 degrees.

Please refer to FIG. 3. The curve C1a shows the distribution of the normalized brightness value versus the viewing angle after the part of light beams is reflected by multiple first light receiving surfaces RS1 of the multiple first optical microstructures MS1 and emits from the light emitting surface 100es (that is, the first light distribution). Moreover, the curve C2a shows the distribution of the normalized brightness value versus the viewing angle after the another part of the light beams is reflected by multiple second light receiving surfaces RS2 of the multiple second optical microstructures MS2 and emits from the light emitting surface 100es (that is, the second light distribution). It should be particularly noted that the peak brightness of the first light distribution near the front viewing angle is significantly higher than the peak brightness of the second light distribution near the front viewing angle, and the full width at half maximum (FWHM) of the first light distribution FWHM1 (that is, the normalized brightness value is greater than or equal to 50% of the viewing angle range) is smaller than the FWHM of the second light distribution FWHM2.

Therefore, the brightness value of the overall light emitting distribution of the backlight module 10 near the front viewing angle may be increased by the disposition of the first optical microstructures MS1. At the same time, the viewing angle range with the brightness value greater than half of the peak brightness may be widened by the disposition of the second optical microstructures MS2. In other words, the FWHM of a target light distribution FWHM3 (as shown in FIG. 4) generated after the superposition of the first light distribution and the second light distribution is greater than the FWHM of the first light distribution FWHM1.

However, the disclosure is not limited thereto. When the display apparatus 1 of FIG. 1 needs to have a higher brightness value near the front viewing angle, and the brightness value changes gentler with the increase in the viewing angle, the superimposed effect of the first light distribution generated by the first optical microstructures MS1 and the second light distribution generated by the optical microstructures MS2 may be utilized to generate the desired target light distribution. For example, the first angle A1 between the first light receiving surface RS1 and the bottom surface 100bs is set to be smaller than the second angle A2 between the second light receiving surface RS2 and the bottom surface 100bs, and the absolute value of the difference between the first angle A1 and the second angle A2 is less than or equal to 12 degrees. In order to increase the smoothness of the brightness change near the front viewing angle, the absolute value of the difference between the first angle A1 and the second angle A2 may be less than or equal to 10 degrees, or even less than or equal to 8 degrees.

Please refer to FIG. 5. The curve C1b shows the distribution of the normalized brightness value versus the viewing angle after the part of light beams is reflected by the multiple first light receiving surfaces RS1 of the multiple first optical microstructures MS1 and emits from the light emitting surface 100es (that is, the first light distribution). Moreover, the curve C2b shows the distribution of the normalized brightness value versus the viewing angle after the another part of the light beams is reflected by the multiple second light receiving surfaces RS2 of the multiple second optical microstructures MS2 and emits from the light emitting surface 100es (that is, the second light distribution). It should be particularly noted that the peak brightness of the first light distribution near the front viewing angle is equivalent to the peak brightness of the second light distribution near the front viewing angle, and the FWHM of the first light distribution FWHM1″ is smaller than the FWHM of the second light distribution FWHM2″. That is, the light concentration of the first light distribution is higher than the light concentration of the second light distribution.

Therefore, the brightness value of the overall light emitting distribution of the backlight module 10 near the front viewing angle may be increased by the disposition of the first optical microstructures MS1 and the second optical microstructures MS2. At the same time, the viewing angle range with the brightness value greater than half of the peak brightness may be widened by the disposition of the second optical microstructures MS2. Since the difference between the FWHM of the first light distribution FWHM1″ and the FWHM of the second light distribution FWHM2″ in FIG. 5 is small than the difference between the FWHM of the first light distribution FWHM1 and the FWHM of the second light distribution FWHM2 in the embodiment of FIG. 3, and the peaks of the two light distributions near the front viewing angle are approximately the same, the brightness value of the target light distribution (as shown in FIG. 6) generated by the superposition of the first light distribution and the second light distribution in FIG. 5 changes gentler with the increase in the viewing angle. In other embodiments, the ratio of the first light distribution and the second light distribution may be adjusted according to design requirements, that is, the number of structures of the first optical microstructures MS1 and the second optical microstructures MS2 may be adjusted in proportion.

Please continue to refer to FIGS. 1 and 2. For example, in the embodiment, the multiple first optical microstructures MS1 and the multiple second optical microstructures MS2 may be arranged alternately along the direction X and the direction Y, and the distribution density may be adjusted according to the needs of different light distributions, which is not limited by the disclosure. From another point of view, the light distribution of the backlight module 10 may further be adjusted through the number ratio of the first optical microstructures MS1 and the second optical microstructures MS2.

The display panel 50 is disposed on one side of the light emitting surface 100es of the light guide plate 100 and overlaps the light emitting surface 100es. In the embodiment, the display apparatus 1 may further optionally include a reflective sheet 130 and an optical film 150. The reflective sheet 130 is disposed on one side of the bottom surface 100bs of the light guide plate 100, and adapted for reflecting a part of the light beams emitted from the bottom surface 100bs back to the light guide plate 100. The reflective sheet 130 is, for example, a white reflective sheet or a silver reflective sheet, but is not limited thereto. The optical film 150 is disposed between the light emitting surface 100es of the light guide plate 100 and the display panel 50. For example, the optical film 150 may be a prism film, a diffusion film, an optical brightness enhancement film, or a combination of the above, but is not limited thereto.

Other embodiments are described as follows to explain the disclosure in detail, and the same components are denoted by the same reference numerals. Moreover, the description of the same technical content is omitted. For the description of the omitted part, reference may be made to the above embodiments, and details are not described in the following embodiments. In particular, the following backlight modules of different embodiments may be used to replace the backlight module of FIG. 1.

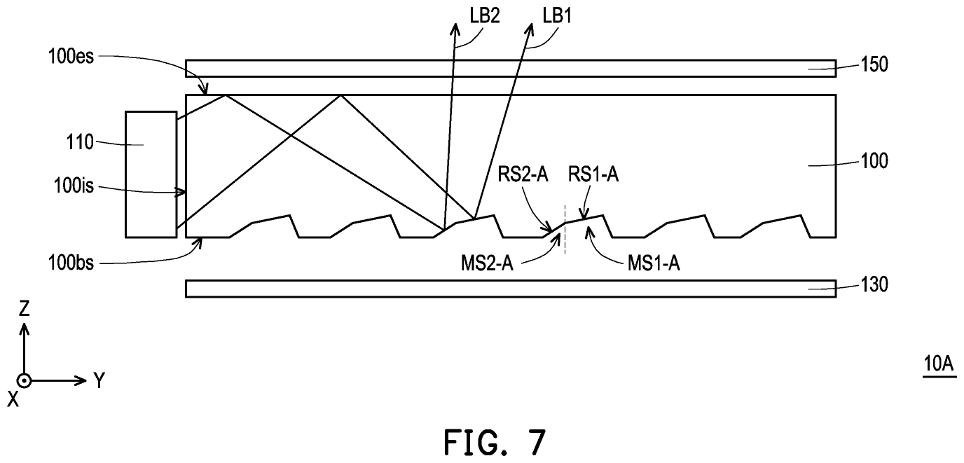

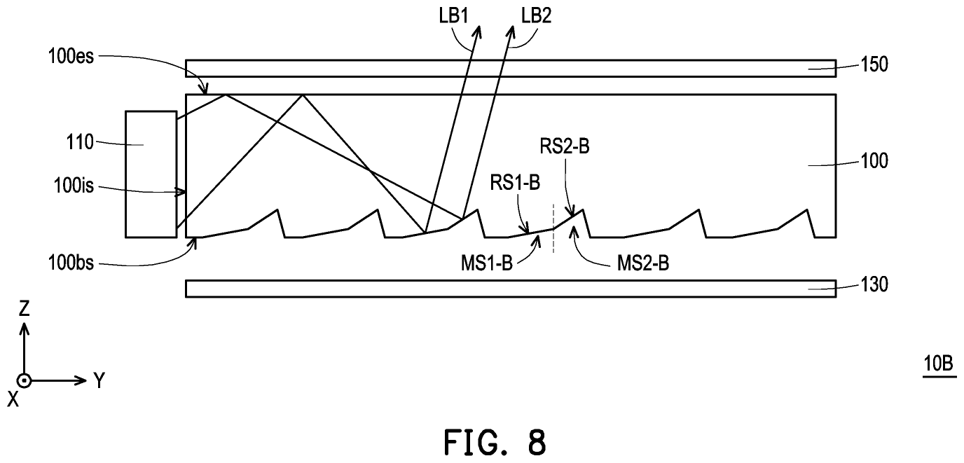

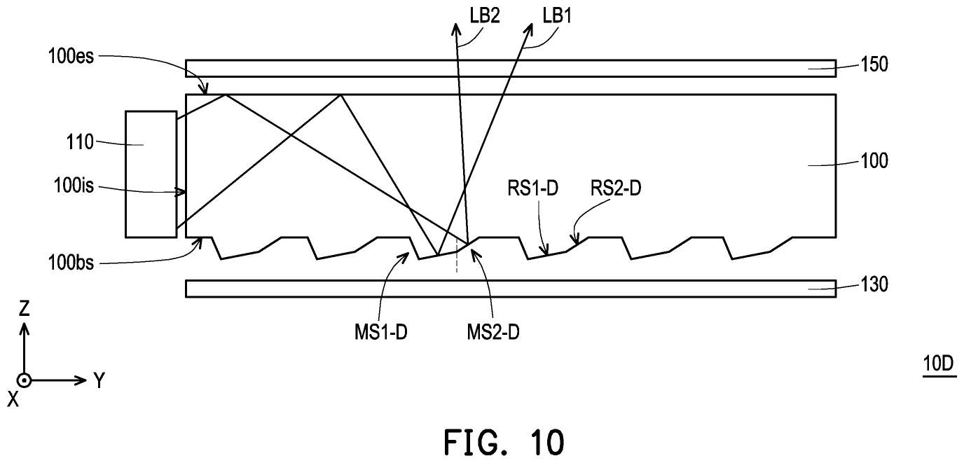

FIG. 7 is a schematic cross-sectional view of a backlight module according to the second embodiment of the disclosure. FIG. 8 is a schematic cross-sectional view of a backlight module according to the third embodiment of the disclosure. FIG. 10 is a schematic cross-sectional view of a backlight module according to the fourth embodiment of the disclosure. Please refer to FIG. 7. The difference between the backlight module 10A of the embodiment and the backlight module 10 of FIG. 1 lies in that the configuration of the optical microstructures is different. In the embodiment, the first optical microstructure MS1-A and the second optical microstructure MS2-A of the backlight module 10A may be connected to each other. For example, the second optical microstructure MS2-A is disposed between the connected first optical microstructure MS1-A and the light source 110. One end of the second light receiving surface RS2-A of the second optical microstructure MS2-A is connected to the first light receiving surface RS1-A of the first optical microstructure MS1-A, and the other end of the second light receiving surface RS2-A is connected to the bottom surface 100bs of the light guide plate 100. That is, the second light receiving surface RS2-A is connected between the first light receiving surface RS1-A adjacent thereto and the bottom surface 100bs. The first light receiving surface RS1-A of the first optical microstructure MS1-A is farther away from the light source 110 than the second light receiving surface RS2-A of the second optical microstructure MS2-A.

However, the disclosure is not limited thereto. In another embodiment, as shown in FIG. 8, the first optical microstructure MS1-B of the backlight module 10B may also be disposed between the connected second optical microstructure MS2-B and the light source 110. One end of the first light receiving surface RS1-B of the first optical microstructure MS1-B is connected to the second light receiving surface RS2-B of the second optical microstructure MS2-B, and the other end of the first light receiving surface RS1-B is connected to the bottom surface 100bs of the light guide plate 100. That is, the first light receiving surface RS1-B is connected between the second light receiving surface RS2-B adjacent thereto and the bottom surface 100bs.

Since the disposition of the respective light receiving surfaces of the first optical microstructures and the second optical microstructures of FIGS. 7 and 8 and the technical effects of the optical microstructures on the backlight module are similar to the disposition and technical effects of the backlight module 10 of FIG. 1, for detailed description, please refer to the relevant paragraphs of the foregoing embodiment, and thus the description is not repeated here.

As the backlight module 10C in FIG. 9, the first optical microstructure MS1-A and the second optical microstructure MS2-A connected in FIG. 7 may also be replaced with the first optical microstructure MS1-D and the second optical microstructure MS2-D of FIG. 10. Specifically, as shown in FIG. 10, the first optical microstructure MS1-D and the second optical microstructure MS2-D of the backlight module 10D may also be convex structures protruding from the bottom surface 100bs out of the body of the light guide plate 100. Therefore, the first optical microstructure MS1-D is disposed between the connected second optical microstructure MS2-D and the light source 110. That is, in the connected first optical microstructure MS1-D and the second optical microstructure MS2-D, the first light receiving surface RS1-D of the first optical microstructure MS1-D is closer to the light source 110 than the second light receiving surface RS2-D of the second optical microstructure MS2-D.

In summary, in the backlight module of an embodiment of the disclosure, the bottom surface of the light guide plate is disposed with two kind of optical microstructures with different light receiving angles. Through the number ratio of the two kind of optical microstructures, backlight modules with different light emitting distributions may be designed to meet various application requirements of display apparatuses.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light guide plate, having a light incident surface, a light emitting surface, and a bottom surface, wherein the light emitting surface and the bottom surface are connected to the light incident surface and opposite to each other;
a light source, disposed on one side of the light incident surface of the light guide plate; and
a plurality of first optical microstructures and a plurality of second optical microstructures, disposed on the bottom surface of the light guide plate, each of the plurality of first optical microstructures having a first light receiving surface facing the light source, and each of the plurality of second optical microstructures having a second light receiving surface facing the light source, wherein a first angle is included between the first light receiving surface and the bottom surface, a second angle is included between the second light receiving surface and the bottom surface, and the second angle is different from the first angle.

2. The backlight module according to claim 1, wherein an absolute value of a difference between the first angle and the second angle is greater than or equal to 5 degrees.

3. The backlight module according to claim 1, wherein an absolute value of a difference between the first angle and the second angle is greater than or equal to 8 degrees.

4. The backlight module according to claim 1, wherein an absolute value of a difference between the first angle and the second angle is greater than or equal to 10 degrees.

5. The backlight module according to claim 4, wherein the light source is adapted to provide a plurality of light beams, a part of the plurality of light beams has a first light distribution after being reflected by the plurality of first receiving surfaces of the plurality of first optical microstructures, and another part of the plurality of light beams has a second light distribution after being reflected by the plurality of second light receiving surfaces of the plurality of second optical microstructures, wherein the first angle is smaller than the second angle, and a full width at half maximum (FWHM) of the first light distribution is smaller than an FWHM of the second light distribution.

6. The backlight module according to claim 1, wherein an absolute value of a difference between the first angle and the second angle is less than or equal to 12 degrees.

7. The backlight module according to claim 1, wherein an absolute value of a difference between the first angle and the second angle is less than or equal to 10 degrees.

8. The backlight module according to claim 1, wherein an absolute value of a difference between the first angle and the second angle is less than or equal to 8 degrees.

9. The backlight module according to claim 8, wherein the light source is adapted to provide a plurality of light beams, a part of the plurality of light beams has a first light distribution after being reflected by the plurality of first receiving surfaces of the plurality of first optical microstructures, and another part of the plurality of light beams has a second light distribution after being reflected by the plurality of second light receiving surfaces of the plurality of second optical microstructures, wherein the first angle is smaller than the second angle, and a light concentration of the first light distribution is higher than a light concentration of the second light distribution.

10. The backlight module according to claim 1, wherein the first light receiving surface of each of the plurality of first optical microstructures is connected between one of the plurality of second light receiving surfaces of the plurality of second optical microstructures adjacent thereto and the bottom surface.

11. The backlight module according to claim 1, wherein the second light receiving surface of each of the plurality of second optical microstructures is connected between one of the plurality of first light receiving surfaces of the plurality of first optical microstructures adjacent thereto and the bottom surface.

12. A display apparatus, comprising:
a backlight module, comprising:
a light guide plate, having a light incident surface, a light emitting surface, and a bottom surface, wherein the light emitting surface and the bottom surface are connected to the light incident surface and opposite to each other;
a light source, disposed on one side of the light incident surface of the light guide plate; and
a plurality of first optical microstructures and a plurality of second optical microstructures, disposed on the bottom surface of the light guide plate, each of the plurality of first optical microstructures having a first light receiving surface facing the light source, and each of the plurality of second optical microstructures having a second light receiving surface facing the light source, wherein a first angle is included between the first light receiving surface and the bottom surface, a second angle is included between the second light receiving surface and the bottom surface, and the second angle is different from the first angle; and
a display panel, disposed on one side of the light emitting surface of the light guide plate and overlapping the light emitting surface.
